(19) United States
(12) Patent Application Publication
(10) Pub. No.: US 2016/0118734 A1
(43) Pub. Date: Apr. 28, 2016

(54) SINGLE FLEX PRINTED WIRING BOARD FOR ELECTRIC SYSTEM CONTROLLER

(71) Applicant: Wes Ralph, Rockford, IL (US)

(72) Inventor: Wes Ralph, Rockford, IL (US)

(73) Assignee: HAMILTON SUNDSTRAND CORPORATION, Charlotte, NC (US)

(21) Appl. No.: 14/857,076

(22) Filed: Sep. 17, 2015

Related U.S. Application Data
(60) Provisional application No. 62/069,636, filed on Oct. 28, 2014.

(51) Int. Cl. H01R 12/70

(52) U.S. Cl. CPC H01R 12/7076

(57) ABSTRACT

According to an aspect of the present invention, there is provided an apparatus that comprises a first printed wiring board and a second printed wiring board that utilize connectors to communicatively couple the apparatus to a processing system. The apparatus further includes at least one additional connector configured to electrically and/or mechanically connect the first and second printed wiring boards so as to eliminate the need for a printed wiring board backplane.

### DOMESTIC PRIORITY

This application is a Non-Provisional of U.S. Provisional Application No. 62/069,636, filed on Oct. 28, 2014, the disclosure of which is incorporated by reference herein in its entirety.

### BACKGROUND OF THE INVENTION

An electric system controller includes large connectors that receive printed wiring board backplanes. Each printed wiring board backplane further includes a plurality of sub-connectors, each of which receives a printed wiring board slot card. In this way, the printed wiring board backplane is used in the electric system controllers to allow for the multiple printed wiring board slot cards to fit into and connect to the electric system controller. However, the printed wiring board backplane unnecessarily expands the dimensions and increases the weight of the electric system controllers when less than three printed wiring board slot cards are utilized. These dimension and weight penalties are especially costly in the aerospace industry, were fuel efficiency directly relates to total vehicle weight.

### BRIEF DESCRIPTION OF THE INVENTION

According to an aspect of the present invention, there is provided an apparatus that comprises a first printed wiring board; a second printed wiring board; a first connector communicatively coupled to the first printed wiring board; a second connector communicatively coupled to the second printed wiring board; and a third connector configured to electrically connect the first and second printed wiring boards.

According to still another aspect of the present invention, there is provided a system that comprises an apparatus, the apparatus further comprising a first printed wiring board; a second printed wiring board; a first connector communicatively coupled to the first printed wiring board; a second connector communicatively coupled to the second printed wiring board; and a third connector configured to electrically connect the first and second printed wiring boards.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an example of a schematic of a device according to one embodiment;

FIG. 2 is another example of a schematic of a device according to one embodiment;

FIG. 3 is another example of a schematic of a device according to one embodiment;

FIG. 4 is another example of a schematic of a device according to one embodiment; and

FIG. 5 is an example of a schematic of a processing system according to one embodiment.

### DETAILED DESCRIPTION OF THE INVENTION

As indicated above, the printed wiring board backplane unnecessarily expands the dimensions and increases the weight of the electric system controllers when less than three printed wiring board slot cards are utilized. Thus, what is needed is a novel mechanical design approach that will remove the necessity for a printed wiring board backplane, resulting in lower cost, weight, and dimensions of the electric system controller.

In general, a device including at least one connector between two printed wiring boards is employed by a processing system (e.g., an electric system controller). For example, in the aerospace industry, a vehicle or aircraft may decrease dimension and weight penalties by utilizing the device described herein in an electric system controller of that vehicle or aircraft. In this way, the vehicle or aircraft will gain fuel efficiency directly related to a decrease in total vehicle weight produced by the employment of the device herein.

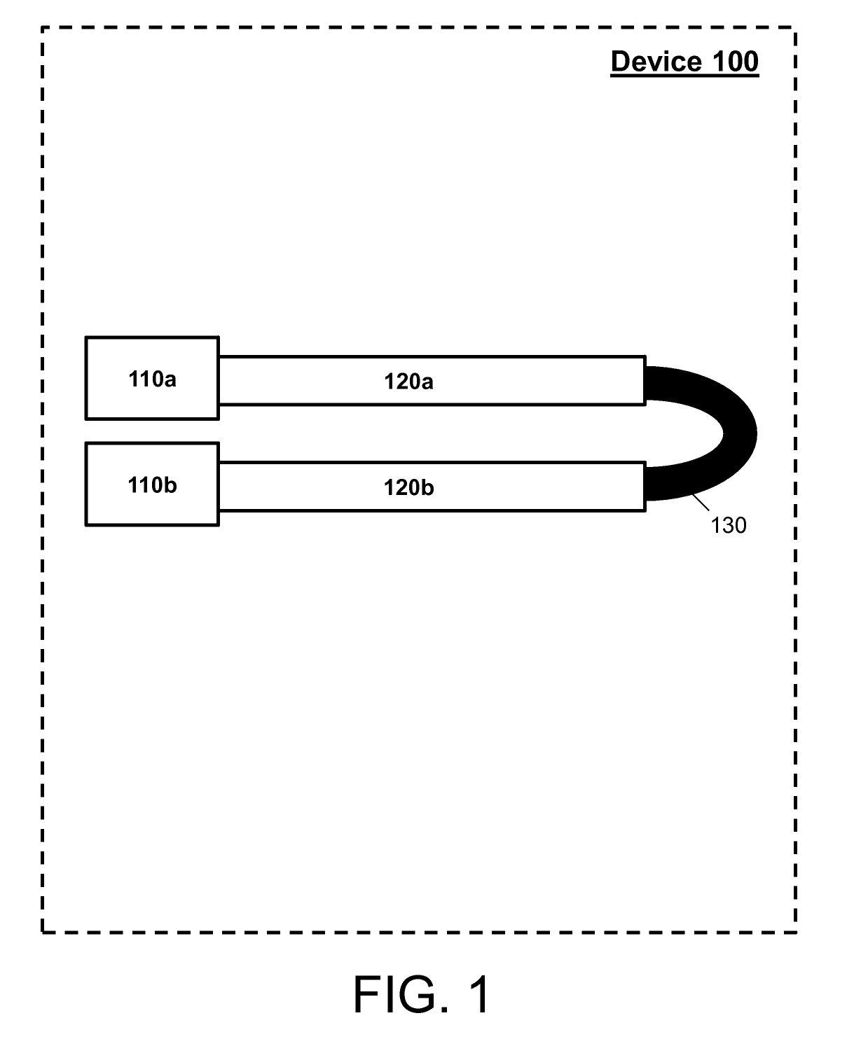

FIG. 1 is an example of a schematic of a device 100 according to one embodiment. The device 100, as illustrated includes connectors 110a, 110b, printed wiring boards 120a, 120b, and a flex connector 130.

The connectors 110a, 110b enable the printed wiring boards 120a, 120b to electrically and mechanically connect to electric system controller and/or any processing device. Examples of the connectors 110a, 110b include right angle connectors that mechanically solder the printed wiring boards 120a, 120b to pins that connect to a processing system.

The printed wiring boards 120a, 120b mechanically support and electrically connect electronic components using conductive tracks, pads, and other features etched from conductive sheets laminated onto a non-conductive substrate. The printed wiring boards 120a, 120b can be single sided (one conductive layer), double sided (two conductive layers) or multi-layer. The different conductive layers can be connected with plated-through holes called vias. Examples of the printed wiring boards 120a, 120b include printed wiring boards configured to control a fuel system and/or an electrical system of an aircraft.

The flex connector 130 is a conductive trace that electrically and mechanically connects the printed wiring boards 120a, 120b to enable communication. The flex connector 130 is capable of being folded onto itself, and thus allowing for the printed wiring boards 120a, 120b to align in parallel as a single processing device 100. In addition, the flex connector 130 enables a unified manufacturing process for the device, in that the flex connector 130 and the printed wiring boards 120a, 120b may be processed, coated, and cleaned as a single unit (e.g., as opposed to individual pieces). Thus, the flex connector 130 enables the device 100 to lower manufacturing costs for a processing system, along with reducing the dimension and weight penalty.

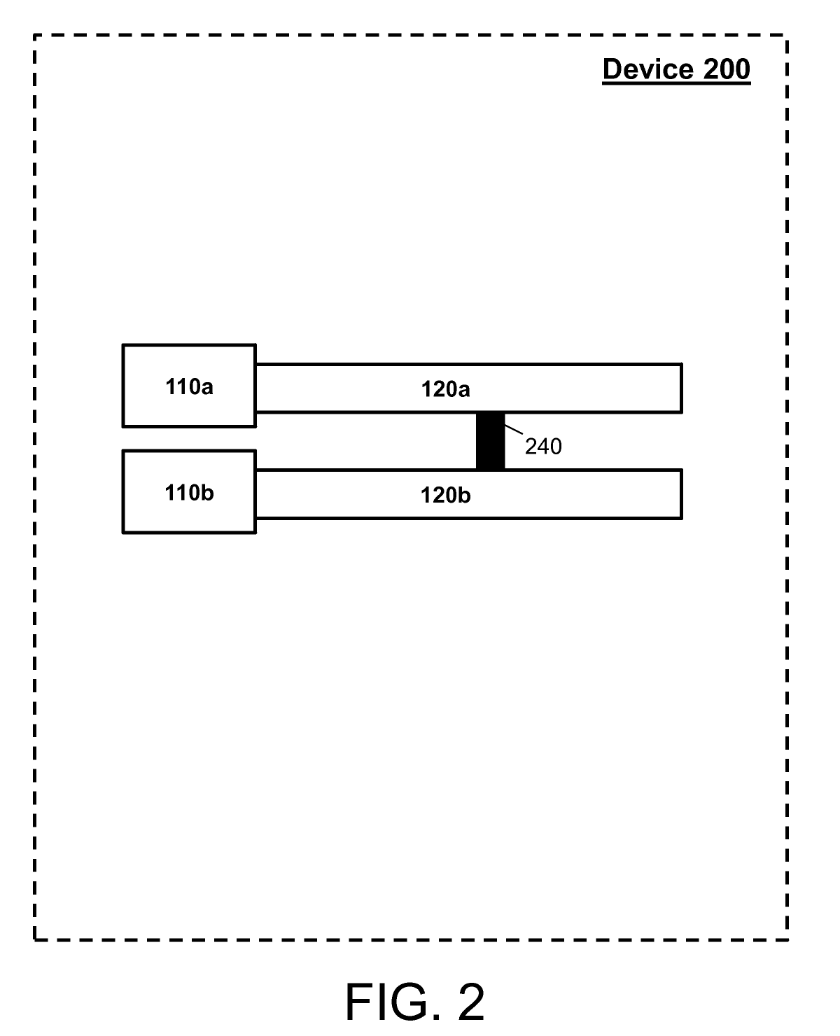

FIG. 2 is another example of a schematic of a device 200 according to one embodiment, where the same reference generally refers to the same components in the embodiments of the present disclosure. The device 200, as illustrated includes connectors 110a, 110b, printed wiring boards 120a, 120b, and a combined inter printed wiring board connector 240.

The combined inter printed wiring board connector 240 is a conductive trace that electrically and mechanically connects the printed wiring boards 120a, 120b to enable communication. The combined inter printed wiring board connector 240 can also serve as a rigid stiffener that mechanically supports the alignment (e.g., stabilizes from movement) the printed wiring boards 120a, 120b in parallel as a single processing device 200. For instance, the combined inter printed wiring board connector 240 secures a strategic positioning, as shown as in FIG. 2, that enables the device 200 to survive a vibration environment of an aircraft.

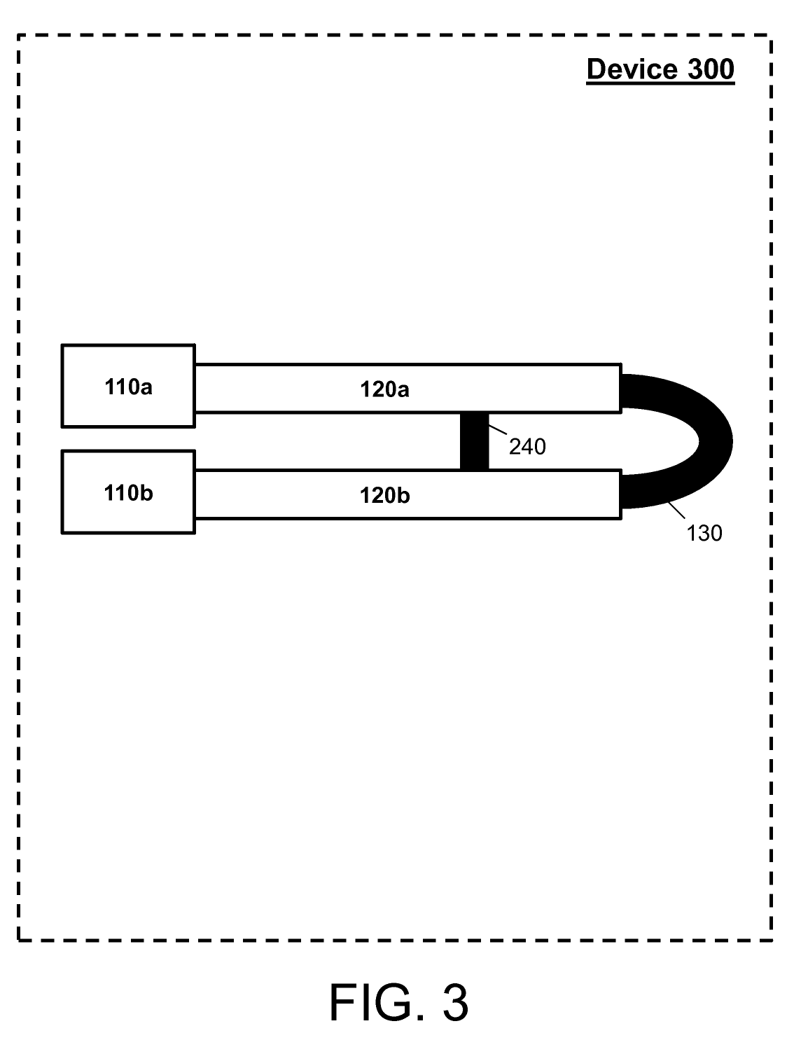

FIG. 3 is another example of a schematic of a device 300 according to one embodiment, where the same reference generally refers to the same components in the embodiments of the present disclosure. The device 300, as illustrated includes connectors 110a, 110b, printed wiring boards 120a, 120b, the flex connector 130, and the combined inter printed wiring board connector 240. In this embodiment, both the flex connector 130 and the combined inter printed wiring board connector 240 are utilized together to provide mechanical and/or electrical support to the device 300. In this way, either or both of the flex connector 130 and the combined inter printed wiring board connector 240 can provide conductive traces between the printed wiring boards 120a, 120b. Further, either or both of the flex connector 130 and the combined inter printed wiring board connector 240 can provide mechanical support between the printed wiring boards 120a, 120b, and thus allowing for the printed wiring boards 120a, 120b to align in parallel as a single processing device 300.

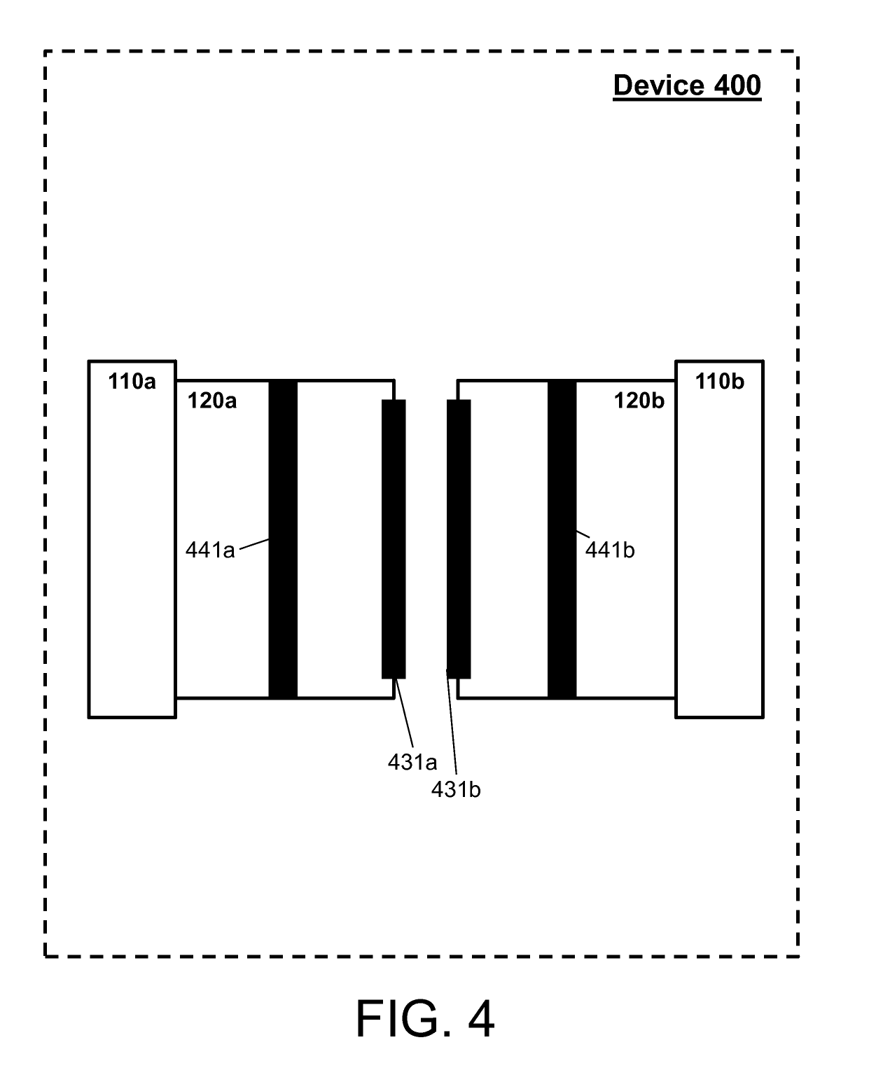

FIG. 4 is another example of a schematic of a device 400 according to one embodiment, where the same reference generally refers to the same components in the embodiments of the present disclosure. The device 400, as illustrated includes connectors 110a, 110b, printed wiring boards 120a, 120b, a flex slots 431a, 431b, and connector slots 441a, 441b. The flex slots 431a, 431b enable a mechanical, an electrical, or a mechanical and electrical flex connector 130 to connect the printed wiring boards 120a, 120b. Similarly, the connector slots 441a, 441b enable a mechanical, an electrical, or a mechanical and electrical printed wiring board connector 240 to connect the printed wiring boards 120a, 120b. Thus, any mechanical and electrical combination of the flex connector 130 and the combined inter printed wiring board connector 240 may be assembled in the device 400.

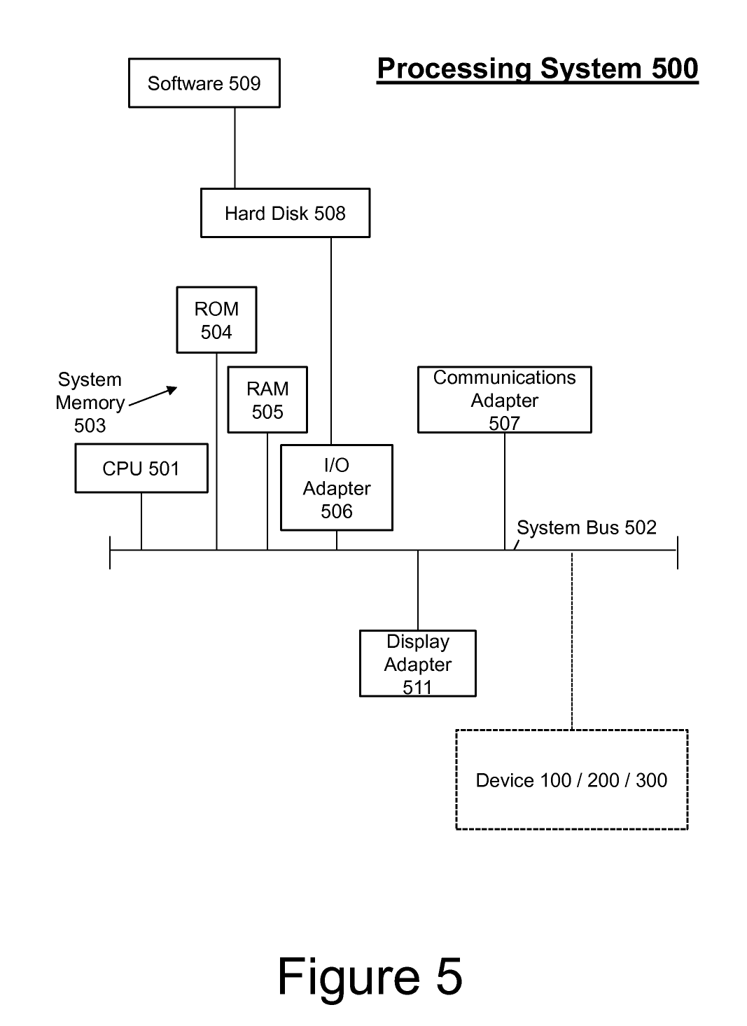

Referring now to FIG. 5, there is shown an embodiment of a processing system 500 for implementing the teachings herein. In this embodiment, the processing system 500 has one or more central processing unit (collectively or generically referred to as processor(s) 501). The processors 501, also referred to as processing circuits, are coupled via a system bus 502 to a system memory 503 and various other components. The system bus 502 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The processing system 500 typically includes a variety of computer system readable media. Such media may be any available media that is accessible by the processing system 500, and it includes both volatile and non-volatile media, removable and non-removable media. For example, a read only memory (ROM) 504 is coupled to the system bus 503 and may include a basic input/output system (BIOS), which controls certain basic functions of the processing system 500. Further the system memory 503 can include a random access memory (RAM) 505, which is read-write memory coupled to the system bus 302 for use by the processors 501.

FIG. 5 further depicts an input/output (I/O) adapter 506 and a communications adapter 507 coupled to the system bus 502. The I/O adapter 506 may be a small computer system interface (SCSI) adapter that communicates with a hard disk 508 and/or tape storage drive or any other similar component. The I/O adapter 506 and the hard disk 508 can be collectively referred to as mass storage. Software 509 for execution on processing system 500 may be stored in mass storage. The mass storage is an example of a tangible storage medium readable by the processors 501, where the software 509 is stored as instructions for execution by the processors 509 to perform operations that improve the performance of the processing system 500.

The communications adapter 507 interconnects the system bus 502 with outside networks enabling the processing system 500 to communicate with other such systems. A screen (e.g., a display monitor) can be connected to the system bus 502 by a display adapter 511, which may include a graphics controller to improve the performance of graphics intensive applications and a video controller. In one embodiment, the adapters 506, 507, and 511 may be connected to one or more I/O buses that are connected to the system bus 511 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices, such as a keyboard, a mouse, a speaker, etc., can be interconnected to the system bus 502 via user other adapters, which may include, for example, a Super I/O chip integrating multiple device adapters into a single integrated circuit.

FIG. 5 further depicts a dashed box representing at least one of the above devices 100, 200, 300 coupled to the system bus 502. The inclusion of the above devices 100, 200, 300 into the processing system 500, in turn, produce the technical effects and benefits of a removal of the printed wiring board backplane and creation of additional space in the processing system 500 for control circuitry, as well as a lighter and smaller processing system 500. An additional technical effect and benefit is that processing the devices 100, 200, 300 as a single unit through the electronics manufacturing process creates cost benefits as compared to manufacturing one printed wiring board backplane and multiple printed wiring board slot cards. In this way, the processing system 500, which may be an electric system controller within an aircraft, will provide fuel efficiency benefits to the aircraft due to the incorporation of at least one of the devices 100, 200, 300, instead of the printed wiring board backplane.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An apparatus, comprising:
a first printed wiring board;
a second printed wiring board;
a first connector communicatively coupled to the first printed wiring board;
a second connector communicatively coupled to the second printed wiring board; and
a third connector configured to electrically connect the first and second printed wiring boards.

2. The apparatus of claim 1, wherein the third connector is a flex connector configured to fold back on itself to enable an alignment of the first and second printed wiring boards in parallel.

3. The apparatus of claim 1, wherein the third connector is a flex connector configured to mechanically hold the first and second printed wiring boards in a parallel alignment.

4. The apparatus of claim 1, wherein the third connector is a printed wiring board connector configured to be a rigid stiffener that mechanically holds the first and second printed wiring boards in a parallel alignment.

5. The apparatus of claim 1, further comprising:
a forth connector configured to mechanically connect and hold the first and second printed wiring boards in parallel.

6. The apparatus of claim 5, wherein the third connector is a flex connector configured to fold back on itself to enable an alignment of the first and second printed wiring boards in parallel, and
wherein the fourth connector is a printed wiring board connector configured to be a rigid stiffener that mechanically holds the first and second printed wiring boards in a parallel alignment.

7. The apparatus of claim 5, wherein the third connector is a printed wiring board connector, and
wherein the fourth connector is a flex connector configured to fold back on itself to mechanically hold the first and second printed wiring boards in a parallel alignment.

8. The apparatus of claim 1, further comprising:
a forth connector configured to electrically connect the first and second printed wiring boards in parallel.

9. The apparatus of claim 1, wherein the first printed wiring board is coupled to the third connector via the first connector, and
wherein the second printed wiring board is coupled to the third connector via the second connector.

10. A processing system comprising the apparatus of claim 1, wherein the first printed wiring board is connected to the processing system via the first connector, and
wherein the second printed wiring board is connected to the processing system via the second connector.

11. The processing system of claim 10, wherein the comprising of the apparatus into the processing system eliminates at least one printed wiring board backplane from the processing system.

12. Wherein the processing system of claim 10 is an electric system controller.

13. An aircraft, comprising the electric system controller of claim 12.
